(19) United States
(12) Patent Application Publication
(10) Pub. No.: US 2010/0202564 A1
(43) Pub. Date: Aug. 12, 2010

(54) ZIGBEE COMMUNICATION APPARATUS AND METHOD FOR HIGH-SPEED TRANSMISSION AND RECEPTION

(76) Inventors: Sang-Yun Hwang, Seoul (KR); Chul-Jin Kim, Gyeonggi-do (KR)

Correspondence Address: THE FARRELL LAW FIRM, LLP, 290 Broadhollow Road, Suite 210E, Melville, NY, 11747, US

(21) Appl. No.: 12/677,717

(22) PCT Filed: Sep. 10, 2008
(86) PCT No.: PCT/KR08/05327

§ 371 Date: Mar. 11, 2010

(30) Foreign Application Priority Data
Sep. 11, 2007 (KR) 10-2007-0091959

(51) Int. Cl. H04L 27/20; H04L 27/00

(52) U.S. Cl. 375/308; 375/295

(57) ABSTRACT

A ZigBee communication apparatus and method for high-speed transmission and reception are provided. The apparatus includes a controller, a first transmission unit, and a second transmission unit. The controller outputs a first control signal controlling high-speed transmission and a second control signal controlling general transmission. The first transmission unit transmits data at high speed when receiving the first control signal. The second transmission unit transmits data at general speed when receiving the second control signal.

### TECHNICAL FIELD

The present invention relates generally to an apparatus and method for transmitting/receiving data at a transmission rate higher than a conventional transmission rate (i.e., 250 Kbps) in a ZigBee system that is one of Wireless Personal Area Network (WPAN) technologies.

### BACKGROUND ART

ZigBee system is one of wireless access technologies used to form a Wireless

Personal Area Network (WPAN) at 800 MHz/900 MHz/2.4 GHz bands. A 2.4 GHz band ZigBee system can support a transmission rate of maximum 250 Kbps and can form a network of maximum 65,536.

FIG. 1 is a diagram illustrating constructions of a transmitter and receiver in a ZigBee system according to the conventional art.

Referring to FIG. 1, in the conventional ZigBee transmitter, a serial-to-parallel converter 100 converts serial data to be output into parallel data. A bit-to-symbol converter 105 converts the parallel data (four bits of 250 Kbps) into one symbol (62.5 Kbps).

A symbol-to-chip converter 110 converts the symbol into sixteen 32-chip sequences.

The converted sequence is a chip sequence of 2 Mcps (32×62.5 Kbps) converted through a spreading process of 32 times. The 32-chip sequence, which is a kind of orthogonal sequence, is used to provide a stable Packet Error Rate (PER) in the ZigBee system with no channel coding by converting data of a low speed into data having a greater bandwidth and transmitting the converted data.

Because using a crystal oscillator with very poor accuracy for the purpose of low cost implementation, the ZigBee system has a very high frequency error (±192 KHz), thus requiring a non-coherent demodulation process. Therefore, such an orthogonal sequence can allow a reception unit to determine a symbol having the highest energy as a reception symbol, thus enabling a non-coherent demodulation process.

An Offset Quadrature Phase-Shift Keying (O-QPSK) modulator 115 can transmit a 1 Mcps chip sequence by I, Q channel through an O-QPSK modulation process. Data transmitted by channel is a chip sequence of a 16-chip length having a transmission rate of 1 Mcps. An O-QPSK modulation scheme has the maximum phase shift width of ±90 degrees and thus, can achieve low cost/low complexity in the ZigBee system because being able to reduce a linear range of a Radio Frequency (RF) transmit end.

A half-sine pulse shaper 120 performs half-sine pulse shaping for data processed by an O-QPSK-modulation process. The half-sine pulse shaping process can be implemented at very low complexity, but disadvantageously requiring a high transmission band compared to a transmission rate of a chip sequence actually transmitted. Although not shown in FIG. 1, a digital-to-analog conversion process is performed after the half-sine pulse shaping process.

A transmission RF unit 125 transmits analog-converted data through an antenna.

In the conventional ZigBee receiver, a reception RF unit 150 receives data. Although not shown in FIG. 1, an analog-to-digital conversion process is performed for the data received by the reception RF unit 150. The digital-converted data (i.e., a 1 Mcps chip sequence of I/Q channel) is forwarded to an O-QPSK demodulator 155.

The O-QPSK demodulator 155 performs a synchronization process to have the knowledge of a start point of a chip sequence received. Demodulated data is processed by the inverse of a transmission process and thus, is converted into data of 250 Kbps passing through a chip-to-symbol converter 160, a symbol-to-bit converter 165, and a parallel-to-serial converter 170.

The conventional ZigBee system can support a 1 Mbps/2 Mbps transmission rate only by a method of decreasing a spreading rate through the modification of a serial-to-parallel converter, a bit-to-symbol converter, and a symbol-to-chip converter.

For example, in order to support a 1 Mbps transmission rate, it is required to perform conversion into sixteen 8-chip sequences. In this case, a length of a chip sequence actually transmitted over I, Q channels is equal to 4. That is, supporting a 1 Mcps transmission rate requires generating sixteen orthogonal sequences of a length of 4 having orthogonality.

However, it is actually difficult to realize this. Thus, in actuality, supporting a 1 Mbps transmission rate requires transmitting the same 1 Mbps data directly to I, Q channels without the serial-to-parallel converter 100, the bit-to-symbol converter 105, and the symbol-to-chip converter 110 of FIG. 1. Further, supporting a 2 Mcps transmission rate requires transmitting different 1 Mbps data to I, Q channels, respectively.

However, in this case, non-coherent demodulation is impossible as above, and there is a problem of making it difficult to expect stable performance because an effect of performance improvement on a PER obtained by using an orthogonal sequence cannot be obtained.

Thus, in actuality, the conventional ZigBee system can provide the maximum transmission rate of 500 Kbps. Undoubtedly, the conventional ZigBee system may increase a transmission rate at the same bandwidth using 8-Phase-Shift Keying (8-PSK), Quadrature Amplitude Modulation (QAM), and multicode system, but has a problem of increasing the requirements for performance of an RF unit and an Analog-to-Digital Converter (ADC)/Digital-to-Analog Converter (DAC) and system complexity.

Also, the conventional ZigBee system has a high frequency error because of having no separate pilot channel and thus, there is a problem that it is difficult to apply a system needing channel measurement based on high reliability such as 8-PSK and QAM.

### DISCLOSURE OF INVENTION

### Technical Solution

An aspect of the present invention is to substantially solve at least the above problems and/or disadvantages and to provide at least the advantages below. Accordingly, one aspect of the present invention is to provide a ZigBee communication apparatus and method for high-speed transmission and reception.

Another aspect of the present invention is to provide a ZigBee communication apparatus and method for enabling high-speed data transmission and reception of 1 Mbps or more in addition to data transmission of 250 Kbps in a ZigBee system.

The above aspects are achieved by providing a ZigBee communication apparatus and method for high-speed transmission and reception.

According to one aspect of the present invention, an apparatus of a ZigBee transmitter supporting high-speed transmission is provided. The apparatus includes a controller, a first transmission unit, and a second transmission unit. The controller outputs a first control signal controlling high-speed transmission and a second control signal controlling general transmission, and controls the apparatus. The first transmission unit transmits data at high speed when receiving the first control signal. The second transmission unit transmits data at general speed when receiving the second control signal.

According to another aspect of the present invention, an apparatus of a ZigBee receiver supporting high-speed transmission is provided. The apparatus includes a controller, a first reception unit, and a second reception unit. The controller outputs a first control signal controlling high-speed reception and a second control signal con-trolling general reception, and controls the apparatus. The first reception unit receives data at high speed when receiving the first control signal. The second reception unit receives data at general speed when receiving the second control signal.

### BRIEF DESCRIPTION OF THE DRAWINGS

The above and other objects, features and advantages of the present invention will become more apparent from the following detailed description when taken in con-junction with the accompanying drawings in which:

FIG. 1 is a diagram illustrating constructions of a transmitter and receiver in a ZigBee system according to the conventional art;

FIG. 2 is a diagram illustrating constructions of a transmitter and receiver in a ZigBee system supporting a 1 Mbps transmission rate according to an exemplary embodiment of the present invention;

FIGS. 3 and 4 are constellations of Offset-Quadrature Phase-Shift Keying (O-QPSK) and π/4-Differential Quadrature Phase-Shift Keying (π/4-DQPSK) according to an exemplary embodiment of the present invention;

FIGS. 5 and 6 are graphs illustrating a comparison of transmission bands between a conventional ZigBee system and a proposed ZigBee system supporting a 1 Mbps transmission rate according to an exemplary embodiment of the present invention;

FIG. 7 is a diagram illustrating constructions of a transmitter and receiver of a ZigBee system supporting a 2 Mbps transmission rate according to an exemplary embodiment of the present invention;

FIGS. 8 and 9 are graphs illustrating a comparison of transmission bands between a conventional ZigBee system and a proposed ZigBee system supporting a 2 Mbps transmission rate according to an exemplary embodiment of the present invention;

FIG. 10 is a diagram illustrating constructions of a transmitter and receiver of a ZigBee system according to an exemplary embodiment of the present invention;

FIG. 11 is a flow diagram illustrating a transmission process of a ZigBee system according to an exemplary embodiment of the present invention;

FIG. 12 is a flow diagram illustrating a reception process of a ZigBee system according to an exemplary embodiment of the present invention; and

FIG. 13 is a graph illustrating a comparison of performance between a conventional ZigBee system and a proposed ZigBee system according to an exemplary embodiment of the present invention.

### BEST MODE FOR CARRYING OUT THE INVENTION

Preferred embodiments of the present invention will be described herein below with reference to the accompanying drawings. In the following description, well-known functions or constructions are not described in detail since they would obscure the invention in unnecessary detail.

An exemplary embodiment of the present invention provides a ZigBee communication apparatus and method for high-speed transmission and reception below.

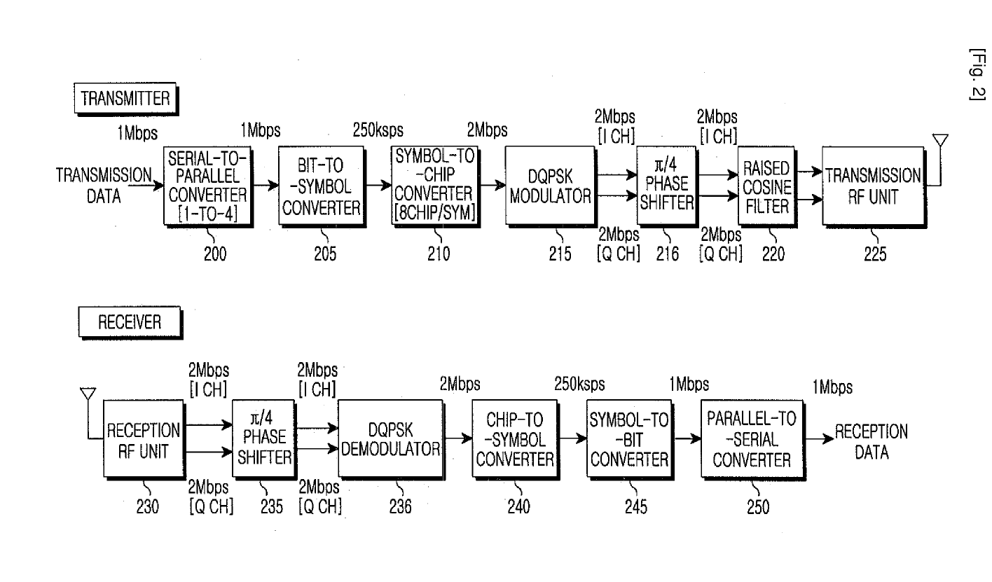

FIG. 2 is a diagram illustrating constructions of a transmitter and receiver in a ZigBee system supporting a 1 Mbps transmission rate according to an exemplary embodiment of the present invention.

Referring to FIG. 2, in a ZigBee transmitter, a serial-to-parallel converter 200 converts serial data to be output into parallel data. A bit-to-symbol converter 205 converts the parallel data (four bits of 1 Mbps) into one symbol (250 Kbps).

A symbol-to-chip converter 210 converts the symbol into sixteen 8-chip sequences. The converted sequence is a chip sequence of 2 Mcps (8×250 Kbps) converted through a spreading process of 8 times.

The sixteen chip sequences of a length of 8 used by the symbol-to-chip converter 210 are selected to minimize a correlation value. The symbol-to-chip converter 210 converts a symbol of four bits into a chip sequence of a length of 8 and thus, can maintain stable PER performance in a reception unit.

A DQPSK modulator 215 modulates the chip sequence of the length of 8. A π/4 phase shifter 216 shifts a phase of the modulated data by π/4.

The DQPSK modulator 215 performs DQPSK modulation and the π/4 phase shifter 216 shifts a phase by π/4 for an output of the symbol-to-chip converter 210 as in Equation 1 below:

MathFigure 1

[Math.1]

s(n)=0.5·s(n−1)·d(n)·(1+j) where s(n)=±1±j, dn=c(n)+j·c(n), c(n)=±1 (1)

where,

c(n): chip sequence,

s(n): modulated and phase-shifted signal,

d(n): data before modulation,

n: current data, and

n−1: previous data.

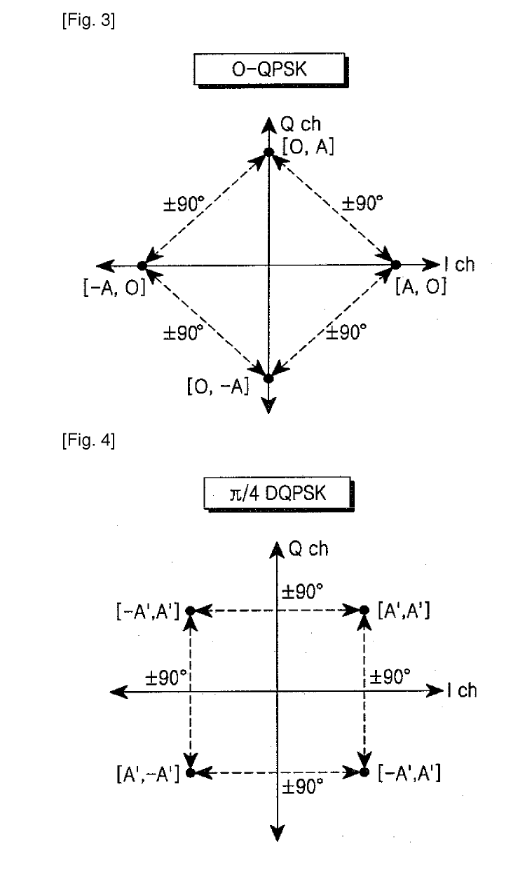

Because the DQPSK modulator 215 has a constellation characteristic of FIG. 4, there is only a phase shift of maximum ±90 degrees as in a conventional ZigBee system of FIG. 3. FIG. 4 shows a phase shift by π/4 after DQPSK modulation.

A raised cosine filter 220 performs raised cosine pulse shaping for the phase-shifted signal.

Because data output from the π/4 phase shifter 216 has a transmission rate of 2 Mbps, a double bandwidth is needed compared to the conventional ZigBee system when using half-sine pulse shaping of the conventional ZigBee system.

Thus, an exemplary embodiment of the present invention minimizes an increase of a bandwidth caused by an increase of a transmission rate, using raised cosine pulse shaping having an efficiency of transmission rate to bandwidth better than half-sine pulse shaping.

Then, although not shown in FIG. 2, a digital to analog conversion process is performed. A transmission RF unit 225 transmits analog-converted data through an antenna.

In a ZigBee receiver, a reception RF unit 230 receives data through an antenna. Then, although not shown in FIG. 2, an analog to digital conversion process is performed.

Digital-converted data (i.e., a 1 Mcps chip sequence of an I/Q channel) is forwarded to a π/4 phase shifter 235. The π/4 phase shifter 235 shifts a phase of the digital-converted data by π/4 and then, forwards the phase-shifted data to a DQPSK de-modulator 236.

The DQPSK demodulator 236 performs a synchronization process to have the knowledge of a start point of a chip sequence received and performs demodulation. The DQPSK demodulator 236 can perform a differential demodulation process at a reception unit as expressed in Equation 2 below and thus, can perform a coherent de-modulation process, thus being able to maintain stable performance at the reception unit.

MathFigure 2

[Math.2]

y(n)=r(n−1)*·r(n)·(1+j)* (2)

y(n): data finishing demodulation,

r(n): analog-to-digital-converted data,

n: current data, and

n−1: previous data.

Then, a chip-to-symbol converter 240, a symbol-to-bit converter 245, and a parallel-to-serial converter 250 convert demodulated data into data of 1 Mbps by the inverse of a transmission process.

That is, the chip-to-symbol converter 240 converts data (i.e., sixteen 8-chip sequences) output from the DQPSK demodulator 236 into a symbol (250 Kbps).

The symbol-to-bit converter 245 converts a symbol (250 Kbps) output from the chip-to-symbol converter 240 into four bits (1 Mbps).

The parallel-to-serial converter 250 converts four bits (1 Mbps) output from the symbol-to-bit converter 245 into serial data.

The ZigBee receiver can perform differential demodulation and thus, can have stable reception performance even against high frequency error.

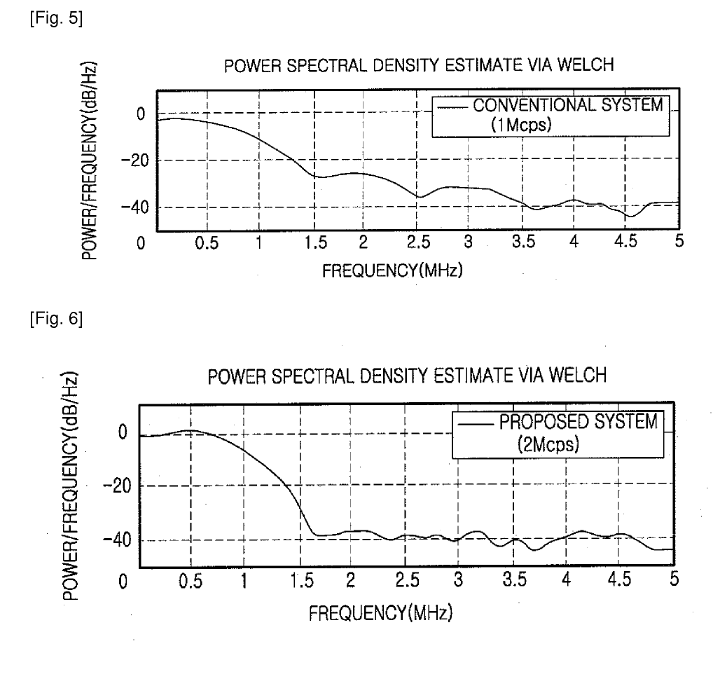

FIGS. 5 and 6 are graphs illustrating a comparison of transmission bands between a conventional ZigBee system and a proposed ZigBee system supporting a 1 Mbps transmission rate according to an exemplary embodiment of the present invention.

Referring to FIGS. 5 and 6, it can be understood that the proposed ZigBee transmitter (b) can have the same transmission bandwidth as the conventional ZigBee system (a) when the roll-off of a raised cosine filter is equal to 0.5.

The proposed ZigBee transmitter can be realized using conventional RF unit and ADC/DAC because having the same phase shift, bandwidth, and level value as the conventional ZigBee system.

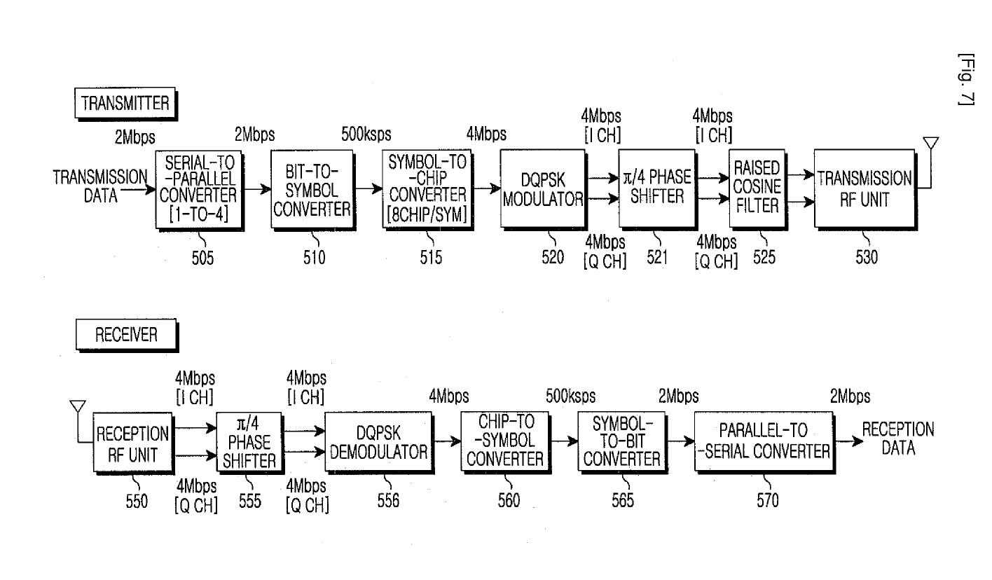

FIG. 7 is a diagram illustrating constructions of a transmitter and receiver of a ZigBee system supporting a 2 Mbps transmission rate according to an exemplary em-bodiment of the present invention.

Referring to FIG. 7, the transmitter and receiver of the ZigBee system supporting the 2 Mbps transmission rate are identical in basic operation with the transmitter and receiver of the ZigBee system supporting the 1 Mbps transmission rate of FIG. 2. That is, functions of blocks 505 to 530 and blocks 550 to 570 are each identical with those of blocks of FIG. 2.

The difference is that an operation clock of the whole block is twice and a transmission bandwidth increases twice compared to 2 Mbps.

However, the ZigBee transmission bandwidth standard is satisfied because there is a characteristic of attenuation of minimum 20 dB at 3.5 MHz as in Table 1 below.

Table 1

TABLE 1

| | Minimum permissible | Minimum permissible |
|---|---|---|
| | power spectral | power spectral |
| Frequency | density relative value | density absolute value |
| \|f − fc\| > 3.5 MHz | −20 dB | −30 dBm |

Table 1 shows the requirements of the ZigBee standard.

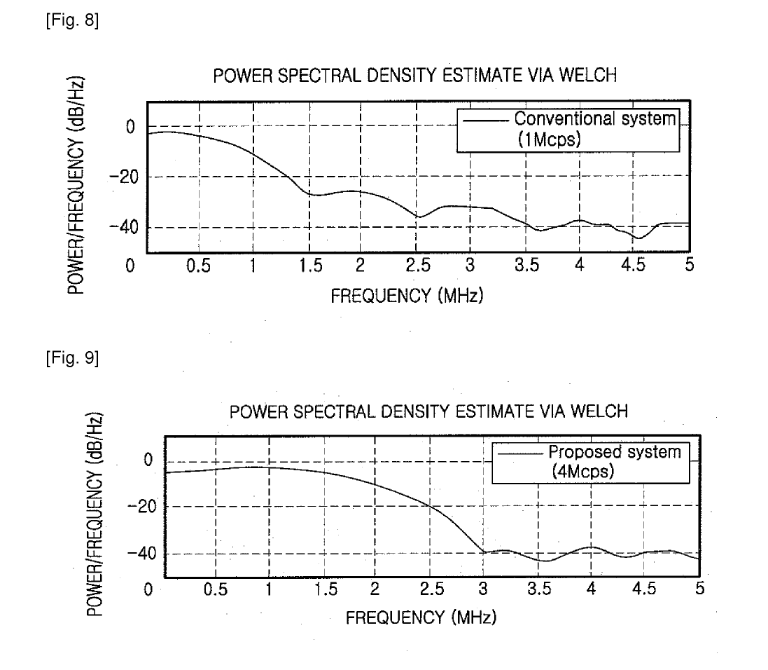

FIGS. 8 and 9 are graphs illustrating a comparison of transmission bands between a conventional ZigBee system and a proposed ZigBee system supporting a 2 Mbps transmission rate according to an exemplary embodiment of the present invention.

Referring to FIGS. 8 and 9, it can be understood that the conventional ZigBee standard is satisfied because a characteristic of attenuation of about 40 dB appears at 3.5 MHz. However, because an order of a raised cosine filter reduces to a half or so of 1 Mbps, even the order of the filter requires a simultaneous change according to a selected transmission rate.

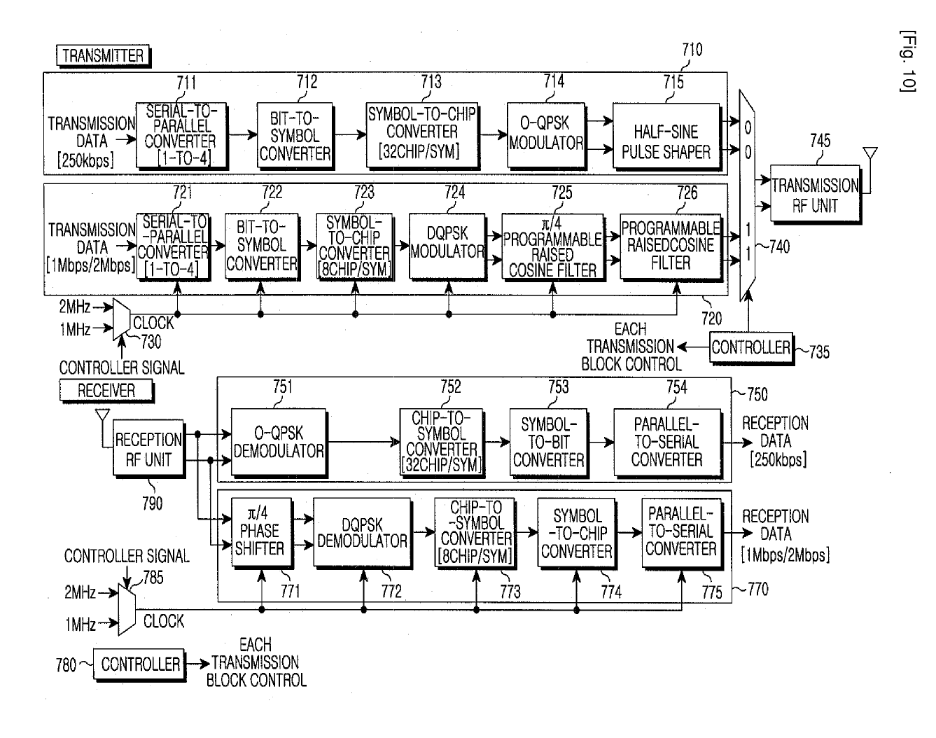

FIG. 10 is a diagram illustrating constructions of a transmitter and receiver of a ZigBee system according to an exemplary embodiment of the present invention.

Referring to FIG. 10, the ZigBee system of an exemplary embodiment of the present invention includes a conventional ZigBee transmitter and receiver and a ZigBee transmitter and receiver for high-speed data transmission according to an exemplary embodiment of the present invention. Operation of each transmitter and receiver is controlled through controllers 735 and 780.

In a transmitter, the controller 735 controls a multiplexer 740 in a high-speed transmission mode and outputs data from a ZigBee transmitter 720 for high-speed transmission, and controls a clock unit 730 to provide high clocks of 1 MHz and 2 MHz to the ZigBee transmitter 720 for high-speed transmission. The controller 735 drives the ZigBee transmitter 720 for high-speed transmission in the high-speed transmission mode. The controller 735 operates a conventional ZigBee transmitter 710 in a general mode.

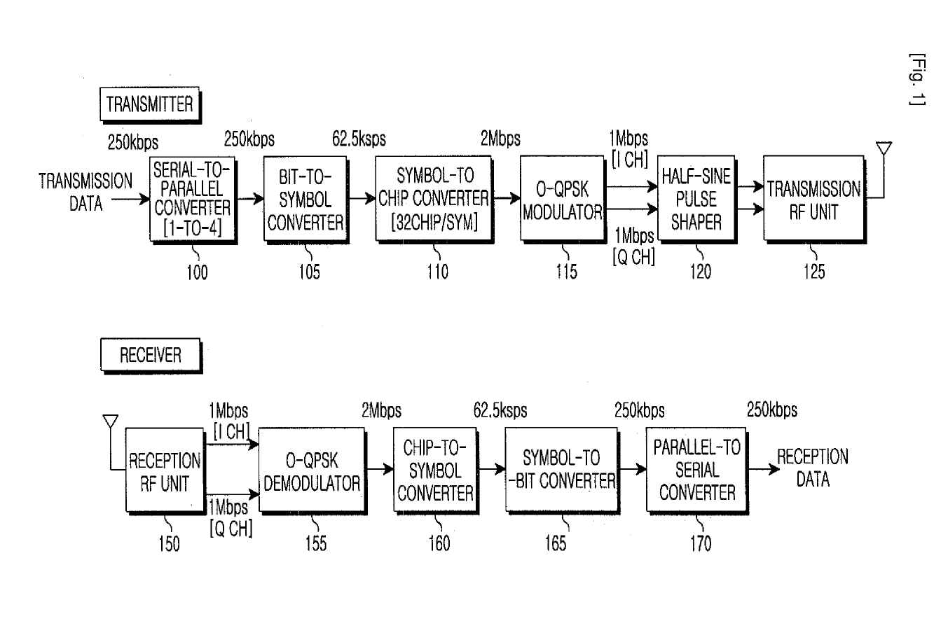

Functions of blocks 721 to 726 of the ZigBee transmitter 720 for high-speed transmission are identical with those of the blocks of FIG. 2 or 7. Functions of blocks 711 to 715 of the conventional ZigBee transmitter 710 are identical with those of the blocks of FIG. 1.

The ZigBee transmitter 720 for high-speed transmission and the conventional ZigBee transmitter 710 share a transmission RF unit 745.

In a receiver, the controller 780 controls a clock unit 785 in a high-speed reception mode to provide high clocks of 1 MHz and 2 MHz to a ZigBee receiver 770 for high-speed reception.

The controller 780 drives the ZigBee receiver 770 for high-speed reception in a high-speed reception mode.

The controller 780 operates a conventional ZigBee receiver 750 in a general mode.

Functions of blocks 771 to 775 of the ZigBee receiver 770 for high-speed transmission are identical with those of the blocks of FIG. 2 or 7. Functions of blocks 751 to 754 of the conventional ZigBee receiver 750 are identical with those of the blocks of FIG. 1.

The ZigBee receiver 770 for high-speed transmission and the conventional ZigBee receiver 750 share a reception RF unit 790.

The functions of the controllers 735 and 780 can be implemented instead by a single controller.

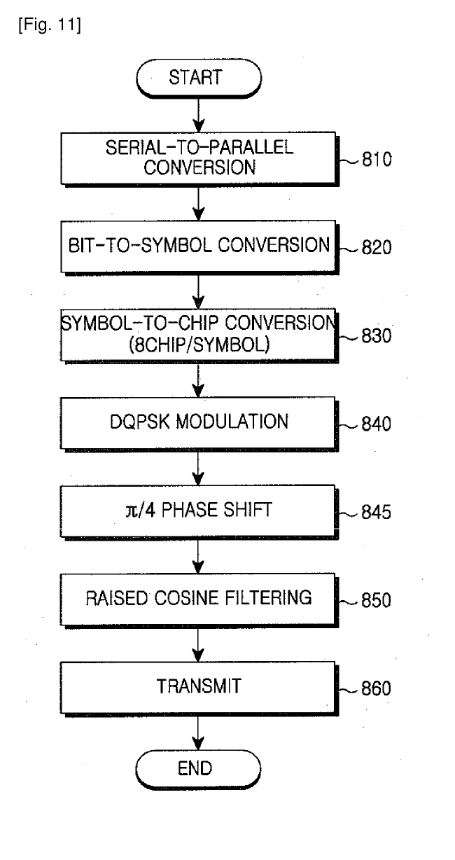

FIG. 11 is a flow diagram illustrating a transmission process of a ZigBee system according to an exemplary embodiment of the present invention.

Referring to FIG. 11, in a ZigBee transmitter of an exemplary embodiment of the present invention, in step 810, a serial-to-parallel converter converts parallel data to be output into serial data (four bits of 1 Mbps).

Then, in step 820, a bit-to-symbol converter converts the serial data (i.e., four bits of 1 Mbps) into one symbol (250 Kbps).

Then, in step 830, a symbol-to-chip converter converts the symbol into sixteen 8-chip sequences. The converted sequence is a chip sequence of 2 Mcps (8×250 Kbps) converted through a spreading process of 8 times. The sixteen chip sequences of a length of 8 used by the symbol-to-chip converter are selected to minimize a correlation value. The symbol-to-chip converter can maintain stable PER performance at a reception unit because converting the symbol of four bits into the chip sequences of the length of 8.

Then, in step 840, a DQPSK modulator modulates the chip sequence of the length of 8.

Then, in step 845, a π/4 phase shifter shifts a phase of the modulated data by π/4.

Then, in step 850, a raised cosine filter performs raised cosine pulse shaping for the phase-shifted signal.

Then, although not shown in FIG. 11, a digital-to-analog conversion process is performed.

Then, in step 860, a transmission RF unit transmits the analog-converted data through an antenna and then, terminates the process of an exemplary embodiment of the present invention.

A clock of 1 MHz or 2 MHz is supplied upon high-speed operation according to an exemplary embodiment of the present invention under control of the controller 735 of FIG. 10.

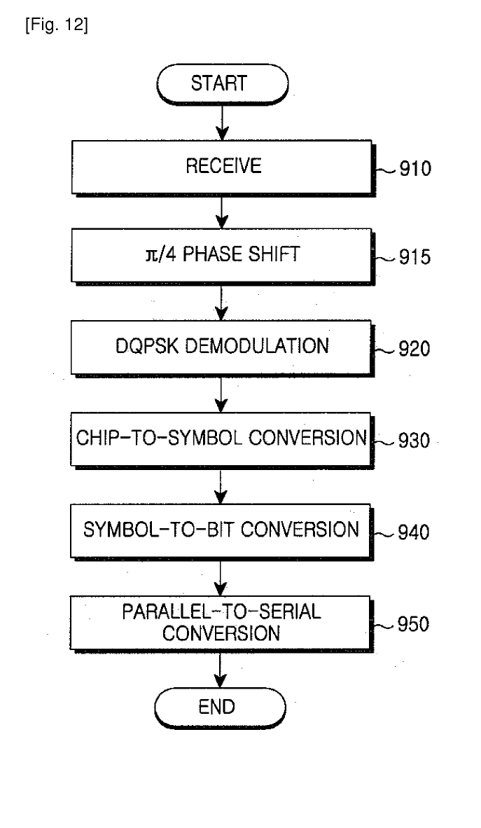

FIG. 12 is a flow diagram illustrating a reception process of a ZigBee system according to an exemplary embodiment of the present invention.

Referring to FIG. 12, in a ZigBee receiver of an exemplary embodiment of the present invention, in step 910, a reception RF unit receives and forwards a 1 Mcps chip sequence of I/Q channel to a π/4 phase shifter.

Then, in step 915, the π/4 phase shifter shifts a phase of the received data by π/4 and forwards the phase-shifted data to a DQPSK demodulator.

Then, in step 920, the DQPSK demodulator performs a synchronization process to have the knowledge of a start point of a chip sequence received and performs de-modulation.

Then, in step 930, a chip-to-symbol converter converts data (i.e., sixteen 8-chip sequences) output from the DQPSK demodulator into a symbol (250 Kbps).

Then, in step 940, a symbol-to-bit converter converts the symbol (250 Kbps) output from the chip-to-symbol converter into four bits (1 Mbps).

Then, in step 950, a parallel-to-serial converter converts four bits (1 Mbps) output from the symbol-to-bit converter into serial data and then, terminates the process of an exemplary embodiment of the present invention.

A clock of 1 MHz or 2 MHz is supplied upon high-speed operation according to an exemplary embodiment of the present invention under control of the controller 780 of FIG. 10. The ZigBee receiver of an exemplary embodiment of the present invention can perform differential demodulation and thus, can have stable reception performance even against high frequency error.

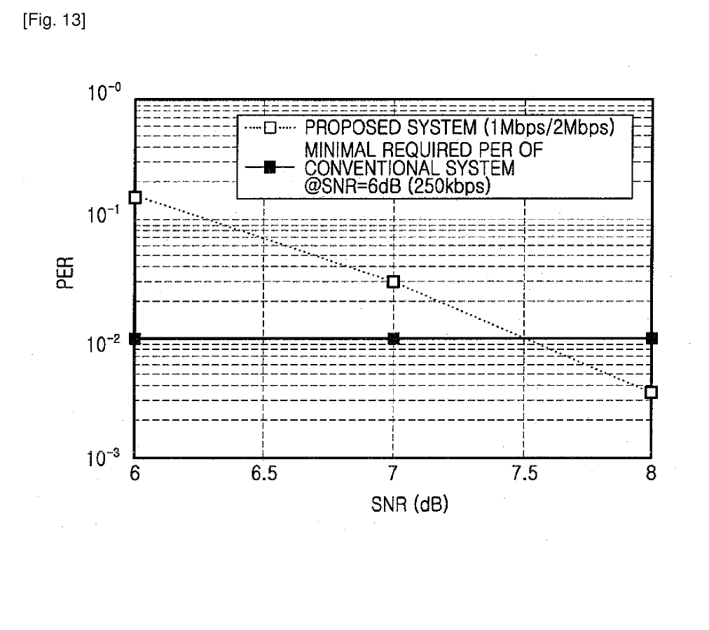

FIG. 13 is a graph illustrating a comparison of performance between a conventional ZigBee system and a proposed ZigBee system according to an exemplary embodiment of the present invention.

FIG. 13 shows the comparison result of performance between a conventional ZigBee system and a ZigBee system supporting a high transmission rate according to an exemplary embodiment of the present invention. The conventional ZigBee system has to satisfy the minimum PER 1% when a Signal to Noise Ratio (SNR) is equal to 6 dB.

When using the same bandwidth, the ZigBee system supporting a high transmission rate according to an exemplary embodiment of the present invention can show four times of performance compared to the conventional ZigBee system, and an actually additionally required SNR is merely equal to 1.5 dB.

Thus, the ZigBee system according to an exemplary embodiment of the present invention can guarantee stable performance while supporting a high transmission rate.

An exemplary embodiment of the present invention has an advantage of enabling stable high-speed data transmission of 1 Mbps/2 Mbps. Also, an exemplary embodiment of the present invention has an advantage of maintaining a conventional ZigBee system as it is, thus being capable of utilizing an RF unit and an ADC/DAC of the conventional ZigBee system as it is.

While the invention has been shown and described with reference to certain preferred embodiments thereof, it will be understood by those skilled in the art that various changes in form and details may be made therein without departing from the spirit and scope of the invention as defined by the appended claims.

1. An apparatus of a ZigBee transmitter supporting high-speed transmission, the apparatus comprising:
a controller for outputting a first control signal controlling high-speed transmission and a second control signal controlling general transmission, and controlling the apparatus;
a first transmission unit for transmitting data at high speed when receiving the first control signal; and
a second transmission unit for transmitting data at general speed when receiving the second control signal.

2. The apparatus of claim 1, wherein the first transmission unit further comprises a clock unit for supplying a clock for high-speed operation.

3. The apparatus of claim 1, wherein the first transmission unit comprises:
a serial-to-parallel converter for performing serial-to-parallel conversion for data intending for transmission;
a bit-to-symbol converter for converting four pieces of target parallel data into one symbol;
a symbol-to-chip converter for converting the one symbol into sixteen 8-chip sequences;
a Differential Quadrature Phase Shift Keying (DQPSK) modulator for differentially modulating the sixteen 8-chip sequences;
a π/4 phase shifter for shifting a phase of the modulated data by π/4; and
a raised cosine filter for performing raised cosine pulse shaping for the phase-shifted data and reducing an increase of a bandwidth caused by an increase of a transmission rate.

4. The apparatus of claim 3, wherein the first transmission unit further comprises:
a digital-to-analog converter for performing a digital-to-analog conversion process for the data finishing the raised cosine pulse shaping; and a Radio Frequency (RF) unit for transmitting the analog-converted data over a radio channel.

5. The apparatus of claim 3, wherein the DQPSK modulator performs DQPSK modulation and the π/4 phase shifter shifts a phase by π/4 for an output of the symbol-to-chip converter as in Equation 3 below:
s(n)=0.5·s(n−1)·d(n)·(1+j) where s(n)±1±j, dn=c(n)+j·c(n), c(n)=±1 (3)
where,
c(n): chip sequence,
s(n): modulated and phase-shifted signal,
d(n): data before modulation,
n: current data, and
n−1: previous data.

6. The apparatus of claim 3, wherein the sixteen 8-chip sequences have the minimum correlation value.

7. An apparatus of a ZigBee receiver supporting high-speed transmission, the apparatus comprising:
a controller for outputting a first control signal controlling high-speed reception and a second control signal controlling general reception, and controlling the apparatus;
a first reception unit for receiving data at high speed when receiving the first control signal; and
a second reception unit for receiving data at general speed when receiving the second control signal.

8. The apparatus of claim 7, wherein the first reception unit further comprises a clock unit for supplying a clock for high-speed operation.

9. The apparatus of claim 7, wherein the first reception unit comprises:
a π/4 phase shifter for shifting a phase of digital-converted data by π/4; a Differential Quadrature Phase Shift Keying (DQPSK) demodulator for performing a differential demodulation process for the phase-shifted data and generating sixteen 8-chip sequences;
a chip-to-symbol converter for converting the sixteen 8-chip sequences into one symbol;
a symbol-to-bit converter for converting the one symbol into four bits; and
a parallel-to-serial converter for converting the four bits into serial data.

10. The apparatus of claim 9, wherein the first reception unit further comprises:
a Radio Frequency (RF) unit for receiving data over a radio channel; and an analog-to-digital converter for performing an analog-to-digital conversion process for the data output from the RF unit.

11. The apparatus of claim 9, wherein the DQPSK demodulator performs a differential demodulation process using Equation 4 below:
y(n)=r(n−1)*·r(n)·(1+j)* (4)
y(n): data finishing demodulation,
r(n): analog-to-digital-converted data,
n: current data, and
n−1: previous data.

12. A transmission method of a ZigBee transmitter supporting high-speed transmission, the method comprising:
outputting a first control signal controlling high-speed transmission or a second control signal controlling general transmission;
first transmitting data at high speed when receiving the first control signal; and second transmitting data at general speed when receiving the second control signal.

13. The method of claim 12, further comprising supplying a clock for high-speed operation before the first transmission process.

14. The method of claim 12, wherein the first transmitting comprises:
performing serial-to-parallel conversion for data intending for transmission;
converting four pieces of target parallel data into one symbol;
converting the one symbol into sixteen 8-chip sequences;
performing Differential Quadrature Phase Shift Keying (DQPSK) modulation for the sixteen 8-chip sequences;
shifting a phase of the modulated data by rr/4; and
performing raised cosine pulse shaping for the phase-shifted data and reducing an increase of a bandwidth caused by an increase of a transmission rate.

15. The method of claim 14, wherein the first transmitting further comprises:
performing digital-to-analog conversion for the data finishing the raised cosine pulse shaping; and
transmitting the analog-converted data over a radio channel.

16. The method of claim 14, wherein performing DQPSK modulation for the sixteen 8-chip sequences and shifting a phase of the modulated data by π/4 are implemented as in Equation 5 below:
s(n)=0.5·s(n−1)·d(n)·(1+j) where s(n±1±j, dn=c(n)+j·c(n), c(n)±1 (5)
where,
c(n): chip sequence,
s(n): modulated and phase-shifted signal,
d(n): data before modulation,
n: current data, and
n−1: previous data.

17. The method of claim 14, wherein the sixteen 8-chip sequences have the minimum correlation value.

18. A reception method of a ZigBee receiver supporting high-speed transmission, the method comprising:
outputting a first control signal controlling high-speed transmission or a second control signal controlling general transmission;
first receiving data at high speed when receiving the first control signal; and
second receiving data at general speed when receiving the second control signal.

19. The method of claim 18, further comprising supplying a clock for high-speed operation before the first reception process.

20. The method of claim 18, wherein the first receiving comprises:
shifting a phase of digital-converted data by π/4;
performing a Differential Quadrature Phase Shift Keying (DQPSK) demodulation process for the phase-shifted data and generating sixteen 8-chip sequences;
converting the sixteen 8-chip sequences into one symbol;
converting the one symbol into four bits; and
converting the four bits into serial data.

21. The method of claim 20, further comprising: before shifting the phase of the digital-converted data by π/4,
receiving data over a radio channel; and
performing an analog-to-digital conversion process for the received data.

22. The method of claim 20, wherein the DQPSK demodulation process uses Equation 6 below:
y(n)=r(n−1)*·r(n)·(1+j)* (6)
y(n): data finishing demodulation,
r(n): analog-to-digital-converted data,
n: current data, and
n−1: previous data.
